(19) United States
(12) Patent Application Publication
(10) Pub. No.: US 2012/0249291 A1
(43) Pub. Date: Oct. 4, 2012

(54) SYSTEMS AND METHODS FOR VEHICLE PASSIVE ENTRY

(75) Inventors: Stephen Holcomb, Livonia, MI (US); Justin McBride, South Lyon, MI (US); Akira Sakashita, Southfield, MI (US)

(73) Assignees: DENSO CORPORATION, Kariya-shi (JP); DENSO INTERNATIONAL AMERICA, INC., Southfield, MI (US)

(21) Appl. No.: 13/100,503

(22) Filed: May 4, 2011

Related U.S. Application Data
(60) Provisional application No. 61/469,034, filed on Mar. 29, 2011.

(51) Int. Cl. G06F 7/04

(52) U.S. Cl. 340/5.51

(57) ABSTRACT

A system for a vehicle includes a sensor and a control module. The sensor detects a gesture made by a user. The control module unlocks the vehicle when (i) a key fob is within a predetermined distance from the vehicle and (ii) the detected gesture matches a desired gesture. A method for a vehicle includes detecting a gesture made by a user using a sensor, and unlocking the vehicle when (i) a key fob is within a predetermined distance from the vehicle and (ii) the detected gesture matches a desired gesture.

### CROSS-REFERENCE TO RELATED APPLICATIONS

This application claims the benefit of U.S. Provisional Application No. 61/469,034, filed on Mar. 29, 2011. The disclosure of the above application is incorporated herein by reference in its entirety.

### FIELD

The present disclosure relates to vehicle passive entry and more particularly to systems and methods for gesture-activated passive entry to a vehicle.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Passive entry systems allow an authorized user to gain entry to their vehicle without physically unlocking the vehicle. For example, the authorized user may unlock and open a door, a hatch, a trunk, or another suitable compartment. Typical passive entry systems operate in conjunction with a key fob in possession of the authorized user. For example, the key fob may remain in a pocket of the authorized user. As the authorized user approaches the vehicle, the passive entry system detects the presence and the proximity of the key fob. When the key fob is within a predetermined distance from the vehicle, the authorized user may unlock the door/hatch/trunk of the vehicle.

### SUMMARY

A system for a vehicle includes a sensor and a control module. The sensor detects a gesture made by a user. The control module unlocks the vehicle when (i) a key fob is within a predetermined distance from the vehicle and (ii) the detected gesture matches a desired gesture.

A method for a vehicle includes detecting a gesture made by a user using a sensor, and unlocking the vehicle when (i) a key fob is within a predetermined distance from the vehicle and (ii) the detected gesture matches a desired gesture.

A passive entry system for a vehicle includes a transceiver, a sensor, and first, second, and third modules. The transceiver communicates with a key fob via radio frequency (RF) communication. The first module monitors a position of the key fob with respect to the vehicle based on data received via the transceiver. The sensor includes (i) an infrared emitter-detector that emits infrared waves and detects a gesture made by a user based on reflected infrared waves, and (ii) a plurality of light emitting diodes (LEDs) used to provide instructive information to the user. The second module detects whether the gesture made by the user matches a desired gesture, wherein data representing the desired gesture is stored in memory. The third module unlocks a locking mechanism associated with a door, trunk, or hatch of the vehicle when (i) the key fob is less than a predetermined distance from the vehicle and (ii) the gesture made by the user matches the desired gesture.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIGS. 1A-1C are views illustrating an example sensors according to various implementation of the present disclosure;

FIG. 2 is a functional block diagram of an example vehicle system according to one implementation of the present disclosure;

FIG. 3 is a functional block diagram of an example control module according to one implementation of the present disclosure; and

FIG. 4 is a flow chart illustrating an example method for gesture-activated passive entry to a vehicle according to one implementation of the present disclosure.

### DETAILED DESCRIPTION

The following description is merely illustrative in nature and is in no way intended to limit the disclosure, its application, or uses. For purposes of clarity, the same reference numbers will be used in the drawings to identify similar elements. As used herein, the phrase at least one of A, B, and C should be construed to mean a logical (A or B or C), using a non-exclusive logical or. It should be understood that steps within a method may be executed in different order without altering the principles of the present disclosure.

As used herein, the term module may refer to, be part of, or include an Application Specific Integrated Circuit (ASIC); an electronic circuit; a combinational logic circuit; a field programmable gate array (FPGA); a processor (shared, dedicated, or group) that executes code; other suitable components that provide the described functionality; or a combination of some or all of the above, such as in a system-on-chip. The term module may include memory (shared, dedicated, or group) that stores code executed by the processor.

The term code, as used above, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The apparatuses and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Typical passive entry systems for vehicles require an authorized user to physically touch the vehicle in order to unlock the vehicle. For example, the authorized user may be required to press a button on a door or to grab a handle near a latch/trunk. Physically touching the vehicle may be cumbersome and/or undesirable for the authorized user. More specifically, passive entry systems that require the authorized user to physically touch the vehicle may cause the authorized user strain and/or may dirty the authorized user's hands.

Accordingly, improved passive entry systems and methods for vehicles are presented. The systems and methods provide for passive entry to a vehicle by an authorized user without physical contact with the vehicle. Specifically, the user may unlock the vehicle when (i) a key fob is within a predetermined distance from the vehicle and (ii) a gesture made by the user matches a desired gesture. The gesture may be detected by a sensor located in proximity to a door/handle/latch of the vehicle. For example, the sensor may be an infrared emitter-detector sensor. In addition, the sensor may be programmable. More specifically, the user may program the desired gesture. Additionally, the sensor may include a plurality of lights for both indicating a status of the sensor and/or directing the user how to proceed.

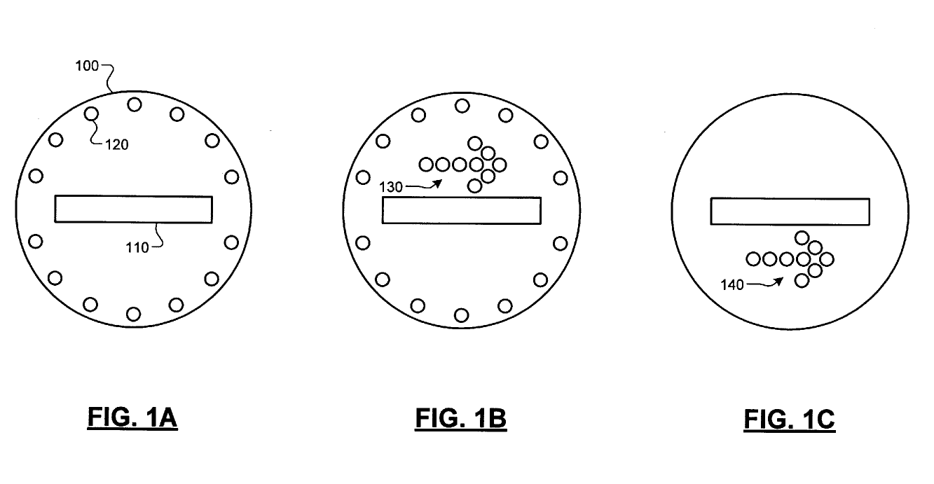

Referring now to FIGS. 1A-1C, examples of a sensor 100 that detects gestures made by a user are shown. For example only, the gestures may be waving motions of the user's hand(s). However, other suitable gestures may be detected and/or desired. The sensor 100 includes an infrared emitter-detector 110 and a plurality of lights 120. The infrared emitter-detector 110 emits infrared waves and detects reflected infrared waves. The reflected infrared waves are detected and interpreted as the gesture made by the user. For example, the plurality of lights 120 may be light emitting diodes (LEDs). The plurality of lights 120, however, may include other suitable lights.

The plurality of lights 120 may also be configured to selectively display to the user that (i) the sensor is ready to detect a gesture, (ii) the sensor has detected a gesture, and/or (iii) the detected gesture matched a desired gesture. For example, FIGS. 1A and 1B illustrate an outer ring of lights that may indicate that the sensor is ready to detect a gesture and/or that the sensor has detected a gesture. Additionally, for example, FIG. 1C illustrates the outer ring of lights being turned off to indicate that the detected gesture matched the desired gesture.

In addition, the plurality of lights 120 may also be configured to display an indication of the desired gesture. For example, FIG. 1B illustrate an arrow 130 indicating a direction of desired movement corresponding to the desired gesture. Indication arrow 130 may be located on a first side of the infrared emitter-detector 110 (e.g., above). In addition, for example, FIG. 1C illustrates an arrow 140 indicating a match of the desired gesture. Indication arrow 140 may be located on a second side of the infrared emitter-detector 110 (e.g., below).

Furthermore, while outer ring and arrow indications are shown, other suitable orientations, shapes, etc. can be displayed by the sensor. Specifically, the sensor 100 may be programmable and therefore the user may program desired indications. For example only, the user may program the sensor 100 to display an indication arrow 130 pointing in an opposite direction of the direction of desired movement corresponding to the desired gesture. Such programming may add additional security for particular unauthorized users (i.e., users unlawfully in possession of the key fob).

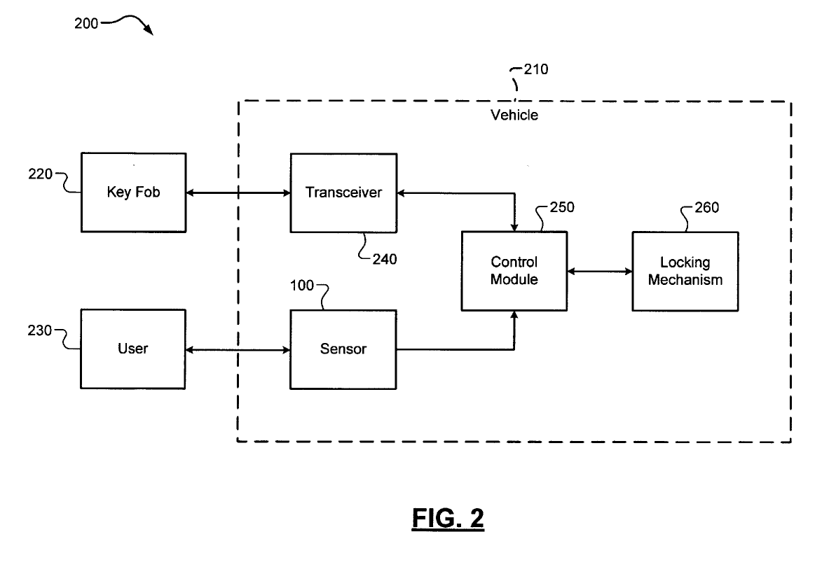

Referring now to FIG. 2, an example vehicle system 200 includes a vehicle 210. The vehicle 210 communicates with a key fob 220 and/or a user 230. The vehicle 210 includes the sensor 100, a transceiver 240, a control module 250, and a locking mechanism 260. While one sensor 210 and one locking mechanism 260 are shown, the vehicle 210 may include other numbers of sensors and/or locking mechanisms 260. For example only, the vehicle 210 may include a sensor 110 and a locking mechanism 260 for each door and for the trunk/hatch.

The transceiver 240 communicates with the key fob 220. For example, the transceiver 240 and the key fob 220 may communicate via radio frequency (RF) communication. However, the transceiver 240 and the key fob 220 may also communicate via other suitable forms of communication and/or communication standards.

The sensor 100 communicates with the user 230. The user 230 may be an authorized user (in possession of the key fob 220) or an unauthorized user (not in possession of the key fob 220). Specifically, the sensor 100 may display information to the user 230 and/or detected gestures made by the user 230. For example, as previously described, the sensor 100 may display that (i) the sensor 100 is ready to detect a gesture, (ii) the sensor 100 has detected a gesture, and/or (iii) the detected gesture matched a desired gesture. Additionally, for example and as previously described, the sensor 100 may detect gestures made by the user 230 via infrared emission-detection (e.g., using infrared emitter-detector 110).

The control module 250 communicates with the transceiver 240 thereby monitoring the position of the key fob 220 with respect to the vehicle 210. Similarly, the control module 250 communicates with the sensor 100 thereby monitoring the gestures made by the user 230. Therefore, the control module 250 may determine whether (i) the key fob 220 is within a predetermined distance from the vehicle 210 and (ii) whether the detected gesture matches the desired gesture. For example only, the predetermined distance may correspond to a distance within an arm's reach of an average user.

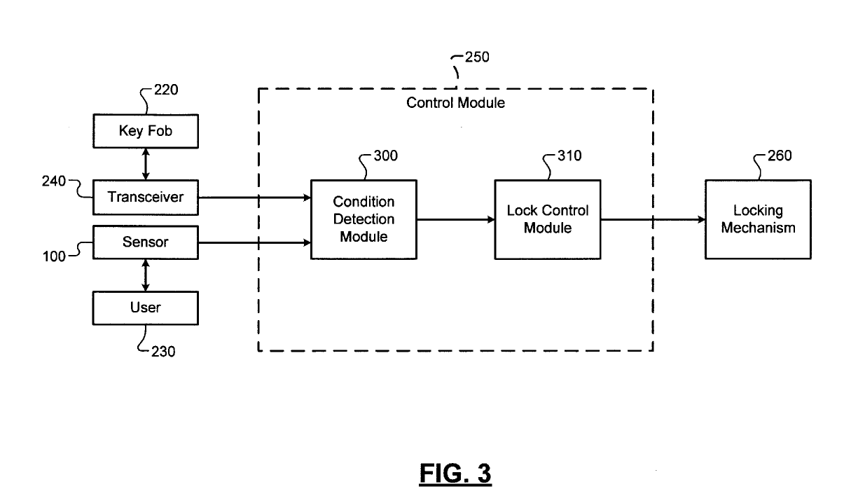

Referring now to FIG. 3, an example of the control module 250 is shown. The control module 250 may include a condition detection module 300 and a lock control module 310. The condition detection module 300 detects whether an authorized user has provided the desired gesture to unlock the vehicle 210. More specifically, the condition detection module 300 may detect whether (i) the key fob 220 is within a predetermined distance from the vehicle 210 (via communication with transceiver 240) and (ii) whether gesture made by the user 230 (detected by sensor 100) matches the desired gesture.

When the key fob 220 is within the predetermined distance from the vehicle 210 and the detected gesture matches the desired gesture, the condition detection module 300 may generate a signal for the lock control module 310 indicating that an authorized user has provided the desired gesture. The lock control module 310 may then unlock the locking mechanism 260 allowing the authorized user may then enter the vehicle 210. For example, the lock control module 310 may generate a signal to unlock the locking mechanism 260.

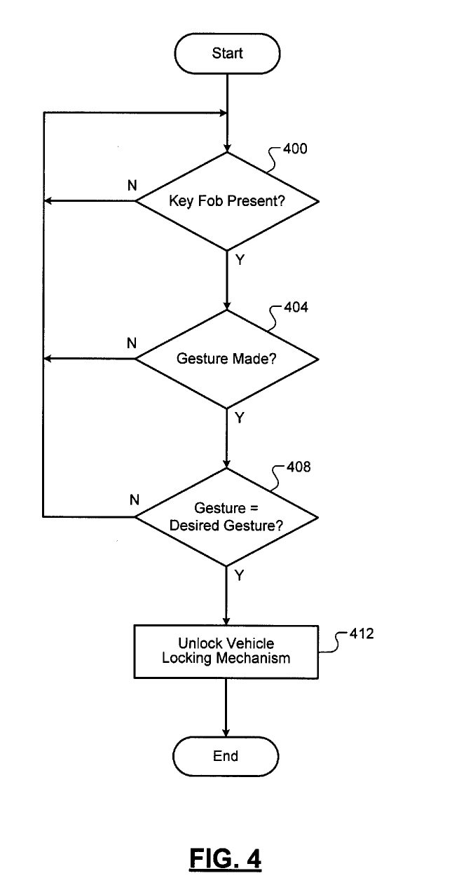

Referring now to FIG. 4, an example method for gesture-activated passive entry to a vehicle begins at 400. At 400, the control module 250 determines whether the key fob 220 is within the predetermined distance from the vehicle 210. If false, control may return to 400. If true, control may proceed to 404. At 404, the control module 250 determines whether a gesture has been made by the user (i.e., detected by sensor 100). If false, control may return to 400. If true, control may proceed to 408. At 408, the control module 250 may determine whether the detected gesture matches the desired gesture. If false, control may return to 400. If true, control may proceed to 412. At 412, the control module 250 may unlock the locking mechanism 260. Control may then end.

The broad teachings of the disclosure can be implemented in a variety of forms. Therefore, while this disclosure includes particular examples, the true scope of the disclosure should not be so limited since other modifications will become apparent to the skilled practitioner upon a study of the drawings, the specification, and the following claims.

What is claimed is:

1. A system for a vehicle, the system comprising:
a sensor that detects a gesture made by a user; and
a control module that unlocks the vehicle when (i) a key fob is within a predetermined distance from the vehicle and (ii) the detected gesture matches a desired gesture.

2. The system of claim 1, wherein the sensor is programmable by the user.

3. The system of claim 2, wherein the user can program the desired gesture.

4. The system of claim 1, wherein the sensor is an infrared emission-detection sensor that emits infrared waves and detects the gesture based on reflected infrared waves.

5. The system of claim 1, wherein the sensor further includes a plurality of lights configured to selectively display to the user that (i) the sensor is ready to detect a gesture, (ii) the sensor has detected a gesture, and (iii) the detected gesture matched the desired gesture.

6. The system of claim 5, wherein the plurality of lights are further configured to display an indication of the desired gesture.

7. The system of claim 6, wherein the indication of the desired gesture is an arrow pointing in a direction of desired movement corresponding to the desired gesture.

8. The system of claim 1, further comprising a transceiver that communicates with the key fob via radio frequency (RF) communication.

9. The system of claim 1, wherein sensor is located near one of (i) a vehicle door handle and (ii) a vehicle trunk handle or latch, and wherein the control module unlocks a locking mechanism associated with the one of the vehicle door handle and the vehicle trunk handle or latch.

10. A method for a vehicle, the method comprising:
detecting a gesture made by a user using a sensor; and
unlocking the vehicle when (i) a key fob is within a predetermined distance from the vehicle and (ii) the detected gesture matches a desired gesture.

11. The method of claim 10, wherein the sensor is programmable by the user.

12. The method of claim 11, further comprising programming the desired gesture based on input from the user.

13. The method of claim 10, wherein the sensor is an infrared emission-detection sensor that emits infrared waves and detects the gesture based on reflected infrared waves.

14. The method of claim 10, wherein the sensor further includes a plurality of lights configured to selectively display to the user that (i) the sensor is ready to detect a gesture, (ii) the sensor has detected a gesture, and (iii) the detected gesture matched the desired gesture.

15. The method of claim 14, wherein the plurality of lights are further configured to display an indication of the desired gesture.

16. The method of claim 15, wherein the indication of the desired gesture is an arrow pointing in a direction of desired movement corresponding to the desired gesture.

17. The method of claim 10, further comprising communicating with the key fob via radio frequency (RF) communication using a transceiver.

18. The method of claim 10, wherein sensor is located near one of (i) a vehicle door handle and (ii) a vehicle trunk handle or latch, and wherein unlocking the vehicle includes unlocking a locking mechanism associated with the one of the vehicle door handle and the vehicle trunk handle or latch.

19. A passive entry system for a vehicle, the passive entry system comprising:
a transceiver that communicates with a key fob via radio frequency (RF) communication;
a first module that monitors a position of the key fob with respect to the vehicle based on data received via the transceiver;
a sensor that includes (i) an infrared emitter-detector that emits infrared waves and detects a gesture made by a user based on reflected infrared waves, and (ii) a plurality of light emitting diodes (LEDs) used to provide instructive information to the user;
a second module that detects whether the gesture made by the user matches a desired gesture, wherein data representing the desired gesture is stored in memory; and
a third module that unlocks a locking mechanism associated with a door, trunk, or hatch of the vehicle when (i) the key fob is less than a predetermined distance from the vehicle and (ii) the gesture made by the user matches the desired gesture.

20. The passive entry system of claim 19, wherein at least one of the sensor and the second module are programmable, and wherein the user can program the desired gesture.
